(19) United States
(12) Patent Application Publication
(10) Pub. No.: US 2010/0198433 A1
(43) Pub. Date: Aug. 5, 2010

(54) Flight Management System with Optimization of the Lateral Flight Plan

(75) Inventors: Stéphanie Fortier, Cugnaux (FR); Jérôme Sacle, Toulouse (FR)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: Thales, Neuilly/Sur/Seine (FR)

(21) Appl. No.: 12/634,128

(22) Filed: Dec. 9, 2009

(30) Foreign Application Priority Data
Dec. 9, 2008 (FR) 0806904

(51) Int. Cl. G06F 19/00; G06F 17/16

(52) U.S. Cl. 701/14; 701/3

(57) ABSTRACT

Flight management system for aircraft comprising computation means capable of determining a gain or a loss in terms of flight time remaining to a point of arrival, and in terms of fuel consumption, following the input by an operator of a modification of an initial flight plan using the Direct To function. The computation means are capable of suggesting to the operator a modification of the lateral flight plan that procures an optimum gain. The flight management system also comprises a display interface capable of presenting to the operator the information concerning the gain or the loss in time and/or consumption, and of prompting the operator to accept or refuse the modification.

### CROSS-REFERENCE TO RELATED APPLICATIONS

This application claims priority of foreign French patent application no. FR 0806904, filed Dec. 9, 2008, the disclosure of which is hereby incorporated by reference in its entirety.

### BACKGROUND OF THE INVENTION

The present invention relates to a flight management system with optimization of the lateral flight plan. It applies to the field of avionics.

Most of the current aircrafts have a flight management system, for example of FMS (Flight Management System) type. These systems provide assistance in navigation, by displaying information useful to the pilots, or else by communicating flight parameters to an automatic piloting system. Notably, a system of FMS type enables a pilot or another qualified person to input, in preflight, a flight plan defined by a point of departure, a point of arrival and a series of waypoints, normally designated by the abbreviation WPT. All these points can be selected from points that are predefined in a navigation database, and that correspond to airports, radionavigation beacons, etc. The points can also be defined by their geographic coordinates and their altitude. Waypoints can be input via a dedicated interface, for example a keyboard or a touchscreen, or else by data transfer from an external system. Other data can be entered into the flight management system, notably data relating to the load plan of the aircraft and to the quantity of fuel on board. When the aircraft is in flight, the flight management system accurately evaluates the position of the aircraft and the uncertainty of this datum, by centralizing the data originating from the various positioning systems, such as the satellite geopositioning receiver, the radionavigation systems: for example DME, NDB and VOR, the inertial unit, etc. A screen enables the pilots to view the current position of the aircraft, and the route followed by the latter, and the closest waypoints, and do so on a map background simultaneously showing other flight parameters and noteworthy points. The information viewed notably enables the pilots to adjust flight parameters, such as the heading, thrust, altitude, rates of climb or descent, and so on, or else simply to monitor the correct progress of the flight if the aircraft is piloted automatically. The computer of the flight management system makes it possible to determine an optimum flight geometry, notably in the sense of a reduction in operating costs, associated with fuel consumption.

It is, however, commonplace for the flight plan to have to be modified during the flight, for example according to requests by the air traffic control organizations, or else in order to circumvent an obstacle generated by unfavourable weather conditions, or simply in order to save time or fuel consumption, etc. Such events can call for minor modifications to the flight plan, and for example for one of the programmed waypoints to be reached directly, without passing through one or more of the intermediate waypoints initially programmed. The modifications of the flight plan can be more significant, and consist in entering a new waypoint, not initially planned. In the latter situation, provision must be made for the flight plan initially planned to be reached via a subsequent waypoint or connection point.

The current flight management systems enable the pilots to input modifications such as the addition of a waypoint that is not initially programmed, or else, for example, the entry of one of the programmed waypoints to be reached directly from the current position. This functionality is known by the name of DIRTO, as described in the ARINC 702 standard entitled Advanced Flight Management Computer System, dated December 1996. The computer of the FMS is then responsible for recomputing the optimum flight parameters according to the new flight plan resulting from the modification. However, within the context of such modifications, it is for the pilots to assess their validity on the basis of the known wind data for the initially planned route. It is notably not possible for the pilots to estimate the reliability of the predictive data computed by the flight management system for the new trajectory resulting from the modifications that have been input. There are even situations in which a modification considered, for example, in order to reduce fuel consumption or flight time will in practice produce results contrary to the results expected. This may be due to different weather conditions on the route as modified, with, for example, headwinds strongly reducing the ground speed of the aircraft.

### SUMMARY OF THE INVENTION

One purpose of the present invention is to propose an onboard flight management system whose computer makes it possible to take into account the weather data within a space surrounding the aircraft, and circumscribed to the potential routes of the latter, to compute the gain or loss generated by the new trajectory, in terms of flight time and fuel consumption. The predictive data can be viewed by the pilot, making him able to take decisions with a more reliable appreciation of their impact. Another benefit of the invention is that it provides, in situations where the modification consists in directly reaching one of the initially planned waypoints, the suggestion of the waypoint presenting the best gain in terms of flight time and/or fuel consumption. Another benefit of the invention is that it provides, in situations where the modification of the flight plan consists in entering a point that is not included among the waypoints initially planned, the suggestion of a point of connection selected in particular conditions from the waypoints initially designated, so as to yield an optimum gain in terms of flight time and/or fuel consumption.

To this end, the subject of the invention is a flight management system for aircraft comprising a data input interface and a display interface, data storage means, means of evaluating the position of the aircraft, computation means, the data input interface enabling an operator to input an initial flight plan by entering the coordinates of a point of departure, of a point of arrival and of a plurality of waypoints, and to input a modification of the initial flight plan resulting in a modified flight plan, characterized in that:
the computation means are capable of determining flight trajectories corresponding to the initial flight plan and to the modified flight plan, the flight times and fuel consumption, from the current position of the aircraft to the point of arrival, via the trajectories of the initial flight plan and of the modified flight plan,
the data storage means are capable of containing wind data, and the computation means are capable of determining a difference between the flight times and fuel consumption to the point of arrival according to the trajectory of the initial flight plan and the flight times and fuel consumption according to the trajectory of the modified flight plan, by computing an actual local wind taking into account the wind data in the spatial area circumscribing at least the trajectories of the initial flight plan and of the modified flight plan,
the display interface is capable of presenting to the operator said difference between the flight times and fuel consumption to the point of arrival according to the trajectory of the initial flight plan and the flight times and fuel consumption according to the trajectory of the modified flight plan.

In one embodiment of the invention, the flight management system is characterized in that the display interface is capable of presenting, following the input of a modification of the initial flight plan, an intermediate display comprising the information giving the difference between the flight times and fuel consumption to the point of arrival according to the trajectory of the initial flight plan and the flight times and fuel consumption according to the trajectory of the modified flight plan, the data input interface enabling the operator to accept or refuse the modification of the initial flight plan.

In one embodiment of the invention, the flight management system is characterized in that the modification of the initial flight plan consists in entering a waypoint from the waypoints of the initial flight plan, intended to be reached directly by the aircraft from its current position.

In one embodiment of the invention, the flight management system is characterized in that the modification of the initial flight plan consists in entering a waypoint that is not included in the waypoints of the initial flight plan, and that is intended to be reached directly by the aircraft from its current position, and in entering a point of connection to the initial flight plan, included among the waypoints of the initial flight plan.

In one embodiment of the invention, the flight management system is characterized in that the computation means are capable of determining all the waypoints of the initial flight plan within a predetermined radius around the current position of the aircraft, and of determining which of these points is the most appropriate to form a waypoint to be reached directly according to predetermined criteria, the display interface also being capable of presenting in said intermediate display the information giving the duly determined waypoint.

In one embodiment of the invention, the flight management system is characterized in that the computation means are capable of determining all the waypoints of the initial flight plan within a predetermined radius around the current position of the aircraft, and of determining which of these points is the most appropriate to form a point of connection to the initial flight plan according to predetermined criteria, the display interface also being capable of presenting in said intermediate display the information giving the duly determined point of connection.

In one embodiment of the invention, the flight management system described above is characterized in that the determined criteria are defined by the best gain in terms of flight time of the aircraft remaining to the point of arrival.

In one embodiment of the invention, the flight management system is characterized in that the determined criteria are defined by the best gain in terms of fuel consumption of the aircraft to the point of arrival.

In one embodiment of the invention, the flight management system is characterized in that the determined criteria are defined by a predetermined index representative of the best gain in terms of flight time of the aircraft remaining to the point of arrival and of the best gain in terms of fuel consumption of the aircraft to the point of arrival.

In one embodiment of the invention, the flight management system described above is characterized in that the wind data comprise a set of two-dimensional wind grids of different altitudes with a determined resolution altitude-wise, the two-dimensional wind grid comprising wind vectors associated with two-dimensional cells delimited by lines defined by determined fractions of degrees of latitude and longitude.

In one embodiment of the invention, the flight management system is characterized in that the computation means are capable of reconstructing a three-dimensional wind grid from a number of two-dimensional wind grids, a three-dimensional cell of the three-dimensional grid being formed by the parallelepiped defined by the vertical projection of a two-dimensional cell of the two-dimensional grid of the higher altitude level onto the immediately lower level.

In one embodiment of the invention, the flight management system described above is characterized in that the wind vector is identical at all points of a three-dimensional cell of the three-dimensional grid, to the wind vector of the two-dimensional cell of the two-dimensional grid of the higher altitude level.

In one embodiment of the invention, the flight management system described above is characterized in that the wind vector is identical at all points of a three-dimensional cell of the three-dimensional grid to the wind vector of the two-dimensional cell of the two-dimensional grid of the lower altitude level.

In one embodiment of the invention, the flight management system described above is characterized in that the wind vector at a point of a given altitude of a three-dimensional cell of the three-dimensional grid is determined by the computation means by a linear interpolation method according to the wind vectors of the two-dimensional cell of the two-dimensional grid of the higher altitude level and of the two-dimensional cell of the two-dimensional grid of the lower altitude level.

In one embodiment of the invention, the flight management system described above is characterized in that the computation means are capable of taking into account all the three-dimensional or two-dimensional cells passed through by the trajectories of the aircraft according to the initial flight plan and the modified flight plan.

In one embodiment of the invention, the flight management system described above also comprises a communication system, characterized in that the wind data can be updated periodically by data communicated via the communication system.

### BRIEF DESCRIPTION OF THE DRAWINGS

Other features and benefits of the invention will become apparent from reading the description, given by way of example, and in light of the appended drawings that represent:

FIG. 1, by a block diagram, the structure of a flight management system of FMS type, known from the state of the art,

FIG. 2, in plan view, the lateral flight profile of an aircraft, according to the programmed flight plan, and according to alternative flight plans,

FIG. 3, an example of the display presented to the pilot in the case of a modification of the flight plan, where it is planned to directly reach a waypoint selected from the waypoints initially planned,

FIG. 4, an example of the display presented to the pilot in the case of a modification of the flight plan, where it is planned to reach a waypoint that was not planned in the initial flight plan,

FIG. 5, an example of the display presented to the pilot in the case of a modification of the flight plan according to the suggestion of the selection of a preferred waypoint,

FIG. 6, the representation of a two-dimensional wind grid,

FIG. 7, in plan view, a vector representation of the computation of the actual wind according to the grid wind on the area concerned, and of the trajectory of the aircraft,

FIG. 8, the representation in isometric perspective, respectively, of an outline of two two-dimensional wind grids relating to two flight levels, and of an outline of a three-dimensional wind grid reconstructed by projections of two-dimensional wind grids, and

FIG. 9, by a block diagram, the structure of a flight management system of FMS type incorporating a wind grid system according to the invention.

### DESCRIPTION OF THE PREFERRED EMBODIMENTS

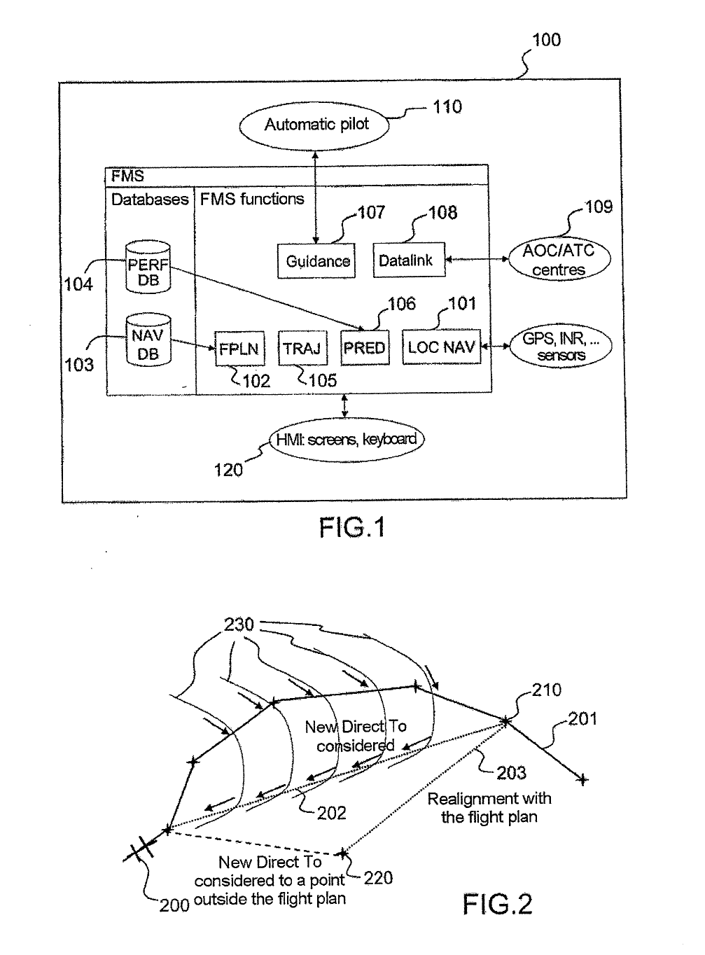

FIG. 1 represents, by a block diagram, the structure of an onboard flight management system of FMS type, known from the state of the art. A system of FMS type 100 has a human-machine interface 120 comprising, for example, a keyboard and display screen, or else simply a touch display screen, and at least the following functions, described in the abovementioned ARINC 702 standard:
navigation (LOCNAV) 101 for carrying out the optimum location of the aircraft according to geolocation means 130 such as satellite geopositioning or GPS, GALILEO, VHF radionavigation beacons, or inertial units. This module communicates with the abovementioned geolocation devices;
flight plan (FPLN) 102, for inputting the geographic elements forming the sketch of the route to be followed, such as the points imposed by the departure and arrival procedures, the waypoints, and the air corridors or airways;
navigation database (NAVDB) 103, for constructing geographic routes and procedures based on data included in the databases relating to the points, beacons, interception or altitude legs, etc.;
performance database (PRFDB) 104, containing the aerodynamic and engine parameters of the craft;
lateral trajectory (TRAJ) 105, for constructing a continuous trajectory from the points of the flight plan, that respects the performance of the aircraft and the required navigation performance constraints (RNP);
predictions (PRED) 106, for constructing a vertical profile optimized on the lateral and vertical trajectory. The functions that are the subject of the present invention affect this part of the computer;
guidance (GUID) 107, for guiding, in the lateral and vertical planes, the aircraft on its three-dimensional trajectory, while optimizing its speed. In an aircraft equipped with an automatic piloting device 110, the latter can exchange information with the guidance module 107;
digital datalink (DATALINK) 108 for communicating with air traffic control centers and other aircrafts 109.

FIG. 2 represents, in plan view, the lateral flight profile of an aircraft 200, according to an initial flight plan 201, and according to a first flight plan 202 modified by the input of a subsequent waypoint 210 to be reached directly, and according to a second flight plan 203 modified by the input of a point 220 that is not included in the waypoints initially planned. Such modifications to the initial flight plan 201 are commonly referred to by those skilled in the art as DIRECT TO or DIRTO. In the example presented in the figure, the initial flight plan 201 is reached, after the aircraft 200 has passed over the point 220, at a point of connection that coincides with the subsequent waypoint 210 to be reached according to the first modified flight plan 202. Winds are represented by wind lines 230, and by arrows representative of the wind vectors along the trajectories corresponding to the initial flight plan 201 and to the first modified flight plan 202. In this example, it appears that a modification of the initial flight plan 201 according to the first modified flight plan 202, that is to say by directly reaching one of the waypoints initially planned, may significantly depart from the trajectory defined by the initial flight plan 201. In such a context, the winds blowing along the modified trajectory may differ radically from the winds blowing along the initial trajectory. Thus, if the purpose of the modification is, for example, to produce a saving in terms of remaining flight time and fuel consumption, or even if it has the result of shortening the flight plan in terms of ground distance, it may paradoxically happen to produce opposite results in practice, because of headwinds along the modified trajectory, whereas crosswinds blow along the initial trajectory. In the example of the figure, modification of the initial flight plan 201 by the input of the new waypoint 220, and a connection to the initial flight plan 201 via the point 210, promises on the other hand to produce a significant gain in terms of flight time and fuel consumption, if, for example, weaker winds or even favourable winds are present along the trajectory 203 resulting from such a modification; it should be noted that, for the sake of clarity, no wind arrow has been represented in the figure, along the trajectory 203.

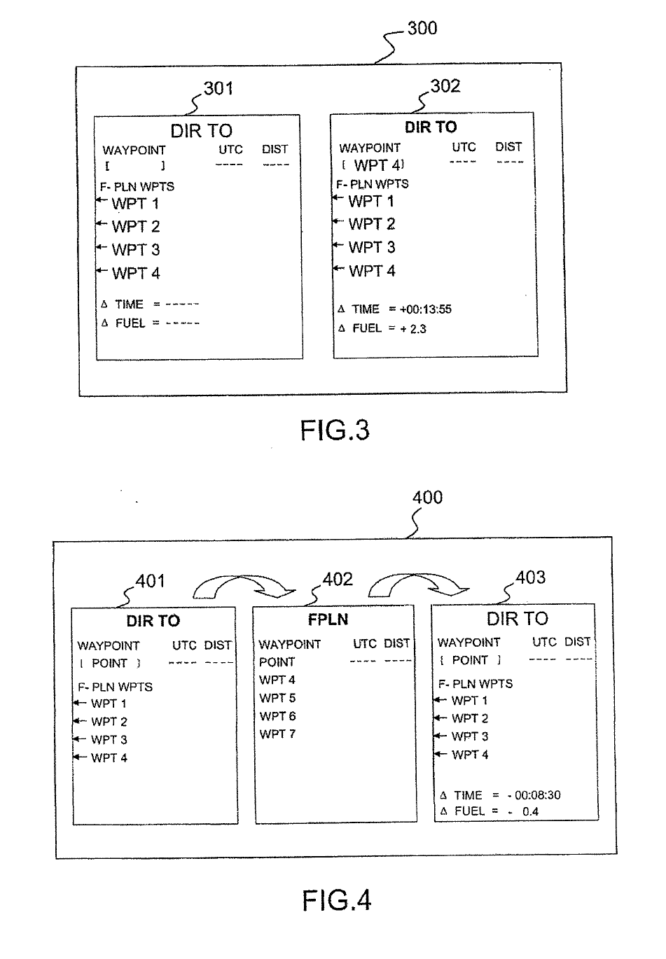

FIG. 3 represents an example 300 of the displays presented to the pilot and to the copilot in the case of a modification of the flight plan where it is planned to directly reach a waypoint from the waypoints initially planned.

A first display 301 follows the call to the DIRTO function by the pilot or the copilot. The call to the DIRTO function is made via a data input interface that is not represented in the figure, and, for example, enables the pilot or the copilot to select one of the waypoints defined in the initial flight plan, to be directly reached from the current position of the aircraft or from the following waypoint. Note that the examples of display presented in this figure and in the subsequent figures are illustrations based on flight management systems of FMS CDU (control and display unit) type with keys. For interactive avionics and new generation FMSs, the concepts are applied with menus featuring cursor selection, instead of command prompts that can be selected by buttons. In the example of the figure, the pilot selects the waypoint WPT 4. The computer of the FMS, not represented in the figure, or possibly a computer external to the FMS but communicating with the latter, evaluates the difference between the remaining flight time following the initial flight plan, and the remaining flight time following the flight plan resulting from the planned modification. In the same way, the computer evaluates the difference between the fuel consumption to the destination, according to the initial flight plan and according to the flight plan resulting from the planned modification.

An intermediate display 302 enables the pilot or the copilot to view the differences Δₜᵢₘₑ and Δ_{fuel} computed in this way, in terms of remaining flight time and fuel consumption to the destination, respectively. Thus, the pilot or the copilot is assisted in his choice, and can then accept the modification, or else consider another and return to the preceding display. In the example of the figure, the planned modification generates an extension of 13 minutes and 55 seconds in terms of planned flight time to destination, and a loss of 2300 kilograms of fuel compared to the fuel consumption resulting from the initial flight plan.

The FMS according to the invention presents an advantage over the FMSs known from the prior art, with which the pilot must exit from the DIRTO display for a flight plan FPLN display enabling him to view only the remaining flight times and fuel consumption to destination (or the quantity of fuel remaining on arrival). He must then review the flight times and fuel consumption to destination relating to the initial flight plan, and make a mental calculation to assess the validity of his manoeuvre.

FIG. 4 represents an example 400 of the displays presented to the pilot and the copilot in the case of a modification of the flight plan, where it is planned to reach a waypoint that is not included in the waypoints initially planned. A first display 401 follows the call to the DIRTO function by the pilot or the copilot. In this example, a waypoint “POINT” not belonging to the set of points forming the initial flight plan, is defined. The pilot is prompted to manually choose a point of connection to the initial flight plan. In the example of the figure, the point WPT 4 is chosen.

A second display 402 enables the pilot to view the successive waypoints according to the flight plan resulting from the planned modification. In this example, the pilot can see that the waypoints WPT 4 and subsequent follow the new waypoint POINT.

A third display 403 enables the pilot to appreciate the validity of the planned modification of the flight plan in terms of time differences and fuel consumption. The computer, not represented in the figure, evaluates the difference between the remaining flight time according to the initial flight plan and the remaining flight time according to the flight plan resulting from the planned modification. In the same way, the computer evaluates the difference between the fuel consumption to destination, according to the initial flight plan and according to the flight plan resulting from the planned modification. Advantageously, the third display 403 is an intermediate display enabling the pilot or the copilot to view the duly computed differences in terms of remaining flight time and fuel consumption to destination, Δₜᵢₘₑ and Δ_{fuel}. The pilot or the copilot can then accept the modification, or else consider another and return to the preceding display. In the example of the figure, the planned modification provides a gain of 8 minutes and 30 seconds in terms of planned flight time to destination, and a gain of 400 kilograms of fuel compared to the fuel consumption resulting from the initial flight plan.

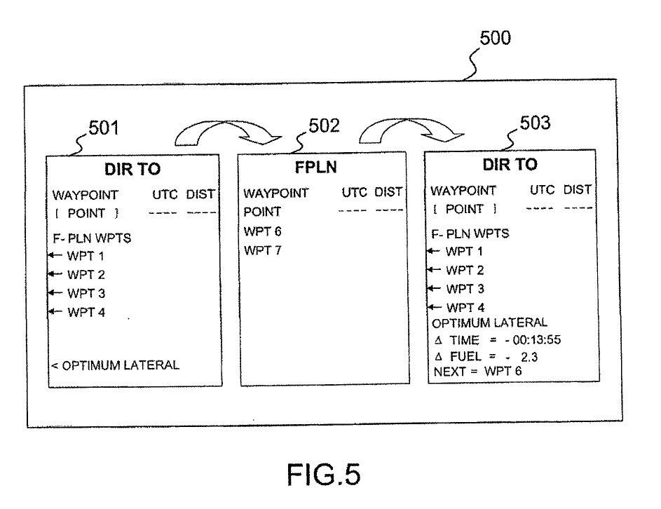

FIG. 5 represents an example 500 of the displays presented to the pilot and the copilot in the case of a modification of the flight plan where it is planned to directly reach a waypoint from the initially planned waypoints.

A first display 501 follows the call to the DIRTO function.

A second display 502 presents a display of the flight plan resulting from the planned modification, with the suggestion of an optimum waypoint to be reached directly. In this example, the pilot is unaware of which waypoint he is seeking to reach directly, and wants to determine the waypoint that will give him the best gain in terms of remaining flight time and fuel consumption to destination. To this end, he is prompted by the first display 501 to call a lateral trajectory optimization function, or OPTIMUM LATERAL. The call to this function orders the computer to perform difference computations concerning remaining flight time and fuel consumption, between the initial flight plan and flight plans modified according to different assumptions. Each assumption corresponds to a direct route to each of the subsequent waypoints designated in the initial flight plan. Advantageously and in order to lighten the workload of the computer, provision may be made for the computations to made only for the points that satisfy determined criteria, for example the waypoints that belong to the initial flight plan, that are located within a maximum radius (for example less than 500 nautical miles), and that do not belong to all the points imposed by the final approach (for example, all the points beyond the final approach location point, or Final Approach Fix FAF). Then, the computer selects the waypoint that provides the best gain in terms of remaining flight time and fuel consumption, provided, obviously, that there is a waypoint that provides such a gain. Advantageously, means may be provided to programme the FMS so as to favour gains exclusively in terms of remaining flight time, or else exclusively in terms of fuel consumption, or else in terms of a composite index both dependent on the gain in time and the gain in fuel consumption.

A third display 503 presents the suggested point and the corresponding gains, Δₜᵢₘₑ and Δ_{fuel}. At this stage, the pilot is prompted to accept the proposed modification or to return to a preceding display. In the example of the figure, the waypoint WPT 6 is suggested, and provides a gain of 13 minutes and 55 seconds in terms of flight time planned to destination, and a gain of 2300 kilograms of fuel compared to fuel consumption resulting from the initial flight plan.

Advantageously, a similar optimization function may be provided, in situations where a waypoint is input that is not included in the waypoints planned in the initial flight plan. In this situation, the function is capable of presenting to the pilot and the copilot a suggestion of the optimum connection point, in a manner comparable to the optimization function described above.

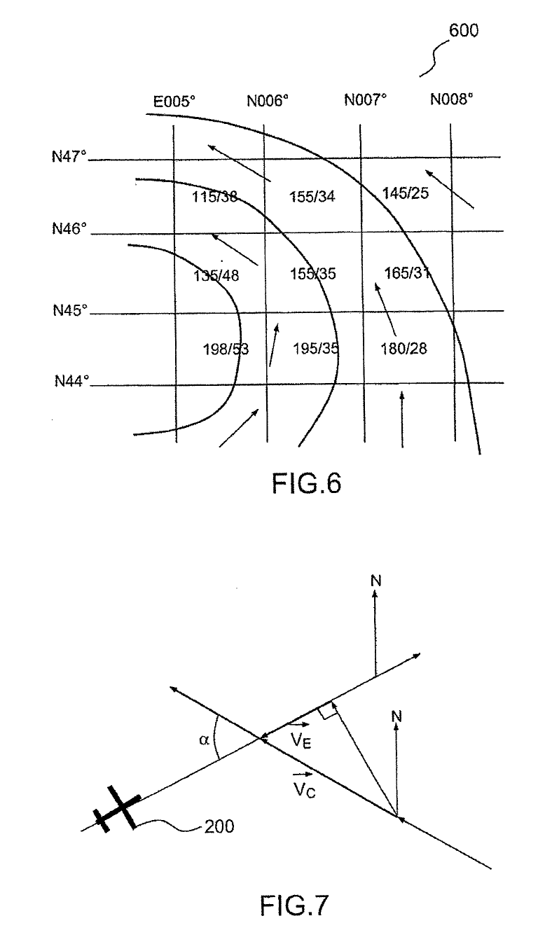

FIG. 6 represents a two-dimensional wind grid 600. The wind grid 600 comprises cells delimited by horizontal lines corresponding to latitudes, and vertical lines corresponding to longitudes. In the example of the figure, the lines are defined by whole numbers of degrees of latitude and longitude, thus providing a resolution of 1°. Obviously, a different scale can be considered, and more or less rough definition grids can exist. Each of the cells contains the datum concerning a wind vector, defined by the wind direction and its speed. A number of wind grids can be associated with as many altitude levels or flight levels, and with temperature values. The coverage of the wind grids can be defined so as to cover all the trajectories that can be reasonably considered for the aircraft between its point of departure and its point of arrival. In the example of the figure, it can be considered, at flight level and at the temperature corresponding to the grid, that the wind blowing in the area defined by the cell delimited by the longitudes N006° and N007°, and the latitudes N45° and N46°, has a direction of 155° and speed of 35 knots.

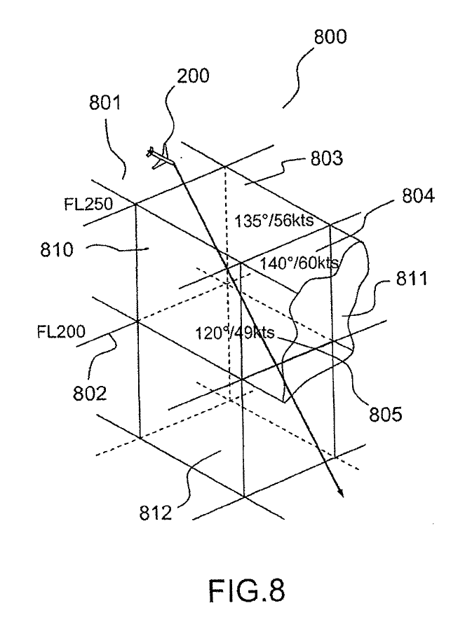

The Grid Wind data are supplied by a weather service and stored before the flight in the memory of the FMS or else in the memory of an onboard system communicating with the FMS. Advantageously, the grid wind data are communicated and regularly updated during the flight via a data communication system of Datalink type. The computer of the FMS, or of an external system communicating with the FMS, takes into account, for the remaining time and fuel consumption estimation computations, the values of the wind vector along the planned trajectory of the aircraft. In order to take account of the flight altitude, the data from the wind grid with the level closest to the altitude of the aircraft can be considered. Advantageously, a three-dimensional wind grid can be reconstructed on the basis of a number of two-dimensional wind grids. Reconstruction methods given by way of example are described with reference to FIG. 8. Alternatively, a three-dimensional wind grid can be directly supplied by a weather service. Thus, at any point of the space, the wind datum can be used for the calculations.

FIG. 7 presents, in plan view, a vector representation 700 of the computation of the actual wind \vec{V}_{E} according to a grid wind referenced relative to magnetic north \vec{V}_{G} on the area concerned, and to the trajectory of the aircraft 200 between its current position and the next waypoint, or target WPT, not represented in the figure. Since a given grid wind is referenced relative to true north, its direction is converted so as to be referenced relative to magnetic north, so all the elements of the figure are referenced relative to magnetic north; the direction of the wind relative to magnetic north is determined by subtracting the magnetic declination of the direction of the wind relative to true north.

The computer of the FMS, or else a computer of an external system that can communicate with the FMS, not represented in the figure, considers the trajectory between the aircraft 200 and the target WPT for the DIRTO or OPTIMUM DIRECT TO function and the grid winds encountered on the trajectory for each wind grid cell that is passed through. Then, the actual wind \vec{V}_{E} is determined by projection of the grid wind \vec{V}_{G} along the trajectory of the aircraft 200, the norm of the actual wind vector \vec{V}_{E} being equal as an absolute value to:

∥\vec{V}_{E}∥=|∥\vec{V_{G}}∥*cos α|,

α being the angle defined by the trajectory of the aircraft 200 and the grid wind \vec{V}_{G} referenced relative to magnetic north.

When the actual wind is obtained for each grid of the direct trajectory from the aircraft 200 to the target WPT, the FMS computes the flight time at the fixed air speed (Mach, CAS) between its current position and the target point. It deduces the difference in terms of flight time or Delta time, and at the planned rate of consumption, the difference in terms of fuel consumption or Delta fuel, by comparison with the trajectory corresponding to the flight plan initially planned.

Advantageously, the function and the associated computations are updated in real time on the temporary flight plan as the aircraft progresses, as long as the activation of the function is not accepted.

Once the function is activated, the FMS can use the measured current wind and the grid wind, performing a blend, to update the predictions along the newly constructed flight plan.

It should be noted that the actual wind can be determined by computing within the magnetic frame of reference or within the true frame of reference, the main thing being that there is consistency between all the orientations that should be defined in one and the same frame of reference.

FIG. 8 presents an isometric perspective view illustrating the outline 800 of two two-dimensional wind grids 801 and 802 for two superimposed flight levels, and a three-dimensional grid reconstructed on the basis of the two two-dimensional grids 801 and 802. In this example, unlike the examples described previously, the aircraft 200 follows a descending trajectory passing through the flight level FL250 and through the flight level FL200. It is therefore necessary for the computer of the FMS, or of an external system communicating with the FMS, not represented in the figure, to be able to determine the actual wind at any point of the trajectory of the aircraft 200. To this end, the computer can proceed according to various methods described hereinbelow, on the basis of the example illustrated by the figure.

In one embodiment of the invention, the computer determines the actual wind on the basis of the wind corresponding to a first cell 803 of the two-dimensional grid passed through at the flight level FL250, or a wind in the direction 135° relative to true north, with a speed of 56 knots. Along the trajectory, the computer bases its actual wind computations solely on this wind, until the trajectory passes through a two-dimensional cell of a two-dimensional grid of an immediately lower flight level for which a wind grid is available. In this case, the wind in the direction 120° relative to true north, with a speed of 43 knots, is considered for all the points of the trajectory of the aircraft 200, from the flight level FL 200 and below, etc.

Advantageously, the computer proceeds with a linear interpolation, so as to determine a wind, between the flight levels FL250 and FL200 in the example of the figure, that varies according to altitude. For example, the wind along the trajectory, at the flight level FL225, is considered to be blowing in a direction of 127.5°, with a speed of 49 knots.

Advantageously, the computer proceeds to reconstruct a three-dimensional grid on the basis of the available two-dimensional wind grids. In the example of the figure, three-dimensional cells 810, 811 and 812 are reconstructed on the basis of the two-dimensional cells 803 and 804 and of the two-dimensional cell 801 corresponding to the flight level FL250, and of the cell 805 of the two-dimensional grid 802 corresponding to the flight level FL200. Thus, the trajectory of the aircraft 200 passes through the cell 810, where the computer bases its computations on the wind in the direction 135° relative to true north, with a speed of 56 knots, until the trajectory of the aircraft 200 passes through the cell 811, where the computer bases its computations on the wind in the direction 140° relative to true north, with a speed of 60 knots, until the trajectory of the aircraft 200 reaches the three-dimensional cell 812, in which the computer bases its computations on the wind in the direction 120° relative to true north, with a speed of 43 knots.

Also advantageously, the wind within a three-dimensional cell reconstructed in this way is defined by a linear interpolation law according to altitude. In the example, for a point along the trajectory of the aircraft, located in the three-dimensional cell 811 at the flight level FL225, the computer bases its computations on the wind in the direction 130° relative to true north, with a speed of 51.5 knots.

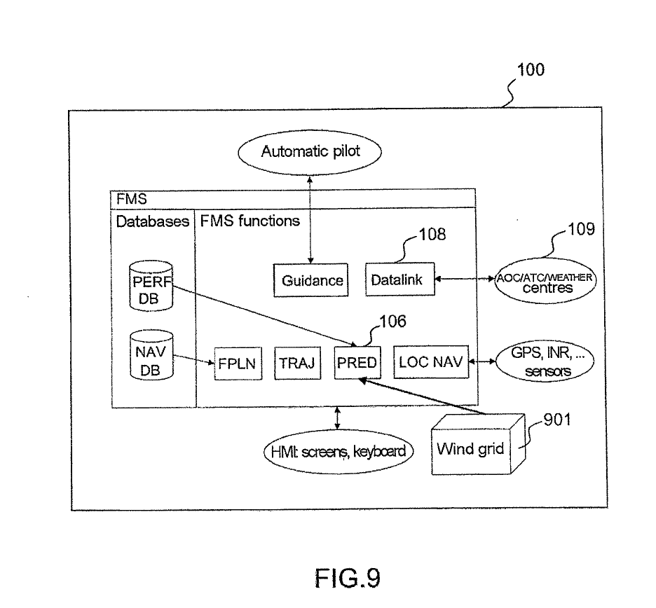

FIG. 9 represents, by a block diagram, the structure of a flight management system of FMS type 100, incorporating a wind grid system 901 according to the invention. The basic structure of an FMS known from state of the art, as represented in FIG. 1, is common to the FMS structure 100 according to the invention. The predictions module of the FMS 100, or PRED 106, communicates with a wind grid module 901. It should be recalled that the wind grids can be stored in a module external to the FMS, or else within the FMS. Advantageously, the wind grids are communicated and regularly updated during the flight by a weather service, via a data communication module of Datalink type 108.

What is claimed is:

1. A flight management system for aircraft comprising a data input interface and a display interface, data storage means, means of evaluating the position of the aircraft, computation means, the data input interface enabling an operator to input an initial flight plan by entering the coordinates of a point of departure, of a point of arrival and of a plurality of waypoints, and to input a modification of the initial flight plan resulting in a modified flight plan,
the computation means being capable of determining flight trajectories corresponding to the initial flight plan and to the modified flight plan, the flight times and fuel consumption, from the current position of the aircraft to the point of arrival, via the trajectories of the initial flight plan and of the modified flight plan,
the data storage means being capable of containing wind data, and the computation means being capable of determining a difference between the flight times and fuel consumption to the point of arrival according to the trajectory of the initial flight plan and the flight times and fuel consumption according to the trajectory of the modified flight plan, by computing an actual local wind \vec{V}_{E} taking into account the wind data in the spatial area circumscribing at least the trajectories of the initial flight plan and of the modified flight plan,
the display interface being capable of presenting to the operator said difference between the flight times and fuel consumption to the point of arrival according to the trajectory of the initial flight plan and the flight times and fuel consumption according to the trajectory of the modified flight plan.

2. The flight management system according to claim 1, wherein the display interface is capable of presenting, following the input of a modification of the initial flight plan, an intermediate display comprising the information giving the difference between the flight times and fuel consumption to the point of arrival according to the trajectory of the initial flight plan and the flight times and fuel consumption according to the trajectory of the modified flight plan, the data input interface enabling the operator to accept or refuse the modification of the initial flight plan.

3. The flight management system according to claim 1, wherein the modification of the initial flight plan comprises entering a waypoint from the waypoints of the initial flight plan, intended to be reached directly by the aircraft from its current position.

4. The flight management system according to claim 1, wherein the modification of the initial flight plan comprises entering a waypoint that is not included in the waypoints of the initial flight plan, and that is intended to be reached directly by the aircraft from its current position, and in entering a point of connection to the initial flight plan, included among the waypoints of the initial flight plan.

5. The flight management system according to claim 1, wherein the computation means are capable of determining all the waypoints of the initial flight plan within a predetermined radius around the current position of the aircraft, and of determining which of these points is the most appropriate to form a waypoint to be reached directly according to predetermined criteria, the display interface also being capable of presenting in said intermediate display the information giving the duly determined waypoint.

6. The flight management system according to claim 5, wherein the determined criteria are defined by the best gain in terms of flight time of the aircraft remaining to the point of arrival.

7. The flight management system according to claim 5, wherein the determined criteria are defined by the best gain in terms of fuel consumption of the aircraft to the point of arrival.

8. The flight management system according to claim 5, wherein the determined criteria are defined by a predetermined index representative of the best gain in terms of flight time of the aircraft remaining to the point of arrival and of the best gain in terms of fuel consumption of the aircraft to the point of arrival.

9. The flight management system according to claim 1, wherein the computation means are capable of determining all the waypoints of the initial flight plan within a predetermined radius around the current position of the aircraft, and of determining which of these points is the most appropriate to form a point of connection to the initial flight plan according to predetermined criteria, the display interface also being capable of presenting in said intermediate display the information giving the duly determined point of connection.

10. The flight management system according to claim 9, wherein the determined criteria are defined by the best gain in terms of flight time of the aircraft remaining to the point of arrival.

11. The flight management system according to claim 9, wherein the determined criteria are defined by the best gain in terms of fuel consumption of the aircraft to the point of arrival.

12. The flight management system according to claim 9, wherein the determined criteria are defined by a predetermined index representative of the best gain in terms of flight time of the aircraft remaining to the point of arrival and of the best gain in terms of fuel consumption of the aircraft to the point of arrival.

13. The flight management system according to claim 1, wherein the wind data comprise a set of two-dimensional wind grids of different altitudes with a determined resolution altitude-wise, the two-dimensional wind grid comprising wind vectors associated with two-dimensional cells delimited by lines defined by determined fractions of degrees of latitude and longitude.

14. The flight management system according to claim 13, wherein the computation means are capable of reconstructing a three-dimensional wind grid from a number of two-dimensional wind grids, a three-dimensional cell of the three-dimensional grid being formed by the parallelepiped defined by the vertical projection of a two-dimensional cell of the two-dimensional grid of the higher altitude level onto the immediately lower level.

15. The flight management system according to claim 14, wherein the wind vector is identical at all points of a three-dimensional cell of the three-dimensional grid, to the wind vector of the two-dimensional cell of the two-dimensional grid of the higher altitude level.

16. The flight management system according to claim 14, wherein the wind vector is identical at all points of a three-dimensional cell of the three-dimensional grid, to the wind vector of the two-dimensional cell of the two-dimensional grid of the lower altitude level.

17. The flight management system according to claim 14, wherein the wind vector at a point of a given altitude of a three-dimensional cell of the three-dimensional grid is determined by the computation means by a linear interpolation method according to the wind vectors of the two-dimensional cell of the two-dimensional grid of the higher altitude level and of the two-dimensional cell of the two-dimensional grid of the lower altitude level.

18. The flight management system according to claim 1, wherein the computation means are capable of taking into account all the three-dimensional or two-dimensional cells passed through by the trajectories of the aircraft according to the initial flight plan and the modified flight plan.

19. The flight management system according to claim 1, further comprising a communication system, wherein the wind data can be updated periodically by data communicated via the communication system.
